(19) United States
(12) Patent Application Publication
(10) Pub. No.: US 2012/0102819 A1
(43) Pub. Date: May 3, 2012

(54) APPARATUS AND METHODS FOR THE EXTERMINATION OF INSECT PESTS

(76) Inventor: PETER NELSEN, BAXTER, MN (US)

(21) Appl. No.: 13/282,378

(22) Filed: Oct. 26, 2011

Related U.S. Application Data
(60) Provisional application No. 61/409,032, filed on Nov. 1, 2010.

(51) Int. Cl. A01M 13/00; A01M 1/20

(52) U.S. Cl. 43/130

(57) ABSTRACT

An extermination apparatus for extermination of insect pests is disclosed herein, In various aspects, the apparatus includes a housing that defines a chamber within. The chamber has a mouth that may be interposed over a surface to be treated, in various aspects. The housing, in various aspects, is, adapted to admit steam from a steam supply into the chamber. A bonnet may be removably disposed over the mouth of the chamber, with the bonnet being permeable to steam to allow the steam to flow from the chamber through the mouth and through the bonnet disposed over the mouth. Related methods of use of the extermination apparatus are also disclosed herein. This Abstract is presented to meet requirements of 37 C.F.R. §1.72(b) only. This Abstract is not intended to identify key elements of the apparatus and methods disclosed herein or to delineate the scope thereof.

### CROSS-REFERENCE TO RELATED APPLICATIONS

This patent application claims priority and benefits of U.S. provisional patent application number 61/409032 entitled “APPARATUS AND METHODS FOR THE EXTERMINATION OF INSECT PESTS” and filed 1 Nov. 2010, which is hereby incorporated by reference in its entirety herein.

### BACKGROUND OF THE INVENTION

1. Field

The present disclosure relates to extermination apparatus and related methods for the treatment of human habitats including the furnishings thereabout to kill insect pests.

2. Background of the Related Art

As used herein, insect pests includes, for example, bedbugs, dust mites, roaches, fleas, and other such crawling insects that infest human habitats including carpets, bedding, and various furnishings within or about human habitats. Bedbugs includes members of C. lectularius and C. hemipterus. Dust mites include the European house dust mite (Dermatophagoides pteronyssinus), the American house dust mite (Dermatophagoides farinae) and Euroglyphus maynei. Roaches include insects of the order Blattaria, and fleas include insects of the order Siphonaptera.

As an example of an insect pest, bedbugs have been known human parasite for thousands of years, and bedbug infestations have been on the increase in developed countries since the 1980's. Human habitats can become infested with bedbugs in a variety of ways: from bugs and eggs carried in on clothing and luggage, from infested items (e.g., furniture, clothes) brought into the home, migration from an adjacent apartment or townhouse, or from rodents or other animals including pets that transport the insect pest into the human habitat. Bedbugs may infest various human habitats such as hotel rooms, movie theaters, restaurants, airline cabins, vehicles such as automobiles and busses, and suchlike, as well as furnishings associated with the human habitat such as bedding, mattresses, chairs, sofas, seating, carpets, and drapes.

Insect pests such as bedbugs may be exterminated by use of pesticides such as pyrethroids, dichlorvos, and malathion as well as DDT and propoxur. However, the use of pesticides may pose risks to human health. Furthermore, insect pests may develop resistance to pesticides.

Mechanical approaches such as vacuuming up the insect pests and heat-treating or wrapping furnishings have been used to exterminate insect pests. For example, furniture such as a sofa or mattress may be placed in a heated chamber to kill the insect pests within the furniture by exposure to heat. Similarly, heaters may be deployed within a dwelling to heat the interior of the dwelling to a temperature sufficient to kill the insect pests within the dwelling.

However, bedbugs, for example, can survive a wide range of temperatures and atmospheric compositions. The thermal death point for C. lectularius is 45° C. (113° F.), and all stages of life are killed by 7 minutes of exposure to 46° C. (115° F.). Application of such heat within a dwelling may damage the structure by, for example, causing window seals to fail, floors to warp, and so forth. As the temperature rises, the bedbugs or other insect pests may simply retreat into walls and other passageways that shield the insect pest from the heat or may evade the heat by retreating into adjacent rooms or apartments only to re-infest the dwelling when the temperature cools.

Because of the limitations of heat treatment and of the use of insecticides, there is a need for improved extermination apparatus and related methods for the treatment of a human habitat including furnishings associated with the human habitat to exterminate insect pests thereabout.

### BRIEF SUMMARY OF THE INVENTION

These and other needs and disadvantages are overcome by the extermination apparatus and related methods disclosed herein. Additional improvements and advantages may be recognized by those of ordinary skill in the art upon study of the present disclosure.

An extermination apparatus for extermination of insect pests is disclosed herein. In various aspects, the extermination apparatus for the extermination of insect pests includes a housing that defines a chamber within. The chamber has a mouth that may be interposed over a region to be treated, the housing configured to admit steam from a steam supply into the chamber, the steam being dispersed through the mouth over the region to be treated, in various aspects.

Methods for treating a region to exterminate insect pests thereabout are disclosed herein. In various aspects, the methods may include the steps of biasing generally a mouth of a housing generally upon a surface of a region, and introducing steam into a chamber of the housing, the steam passing from the chamber through the mouth onto the region, the steam having sufficient temperature to exterminate insect pests that may be present about the region.

This summary is presented to provide a basic understanding of some aspects of the extermination apparatus and methods disclosed herein as a prelude to the detailed description that follows below. Accordingly, this summary is not intended to identify key elements of the extermination apparatus and methods disclosed herein or to delineate the scope thereof.

### BRIEF DESCRIPTION OF THE DRAWINGS

FIG. 1A illustrates by perspective view an exemplary extermination apparatus;

FIG. 1B illustrates by cut-away frontal view portions of the exemplary extermination apparatus of FIG. 1A;

FIG. 2A illustrates by frontal view portions of the exemplary extermination apparatus of FIG. 1A including a steam line end of a steam tube;

FIG. 2B illustrates by bottom view portions of the exemplary extermination apparatus of FIG. 1A including the steam line end of a steam tube received within a coupling;

FIG. 3 illustrates by perspective view portions of another exemplary extermination apparatus;

FIG. 4 illustrates by perspective view portions of a third exemplary extermination apparatus;

FIG. 5 illustrates by perspective view portions of a fourth exemplary extermination apparatus;

FIG. 6 illustrates by plan view a bonnet portion of an exemplary extermination apparatus;

FIG. 7A illustrates by bar graph experimental results obtained for the heat characteristics in Degree-Seconds above 50° C. (or 122° F.) from various steam nozzles at a surface of a material being treated;

FIG. 7B illustrates by bar graph experimental results obtained for the heat characteristics in Degree-Seconds above 50° C. (or 122° F.) from various steam nozzles at a depth of 13 mm within the material being treated;

FIG. 7C illustrates by bar graph experimental results obtained for the heat characteristics in at a depth of 13 mm within the material being treated (or 122° F.) from various steam nozzles at a depth of 26 mm within the material being treated; and,

FIG. 8 illustrates experimental results for bedbug mortality as a function of Degree-Seconds above 50° C. by Cartesian scatter plot.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof.

### DETAILED DESCRIPTION OF THE INVENTION

Extermination apparatus and associated methods for extermination of insect pests are presented herein. In various aspects, the extermination apparatus comprises a housing. The housing, in various aspects, defines a chamber therein. The housing defines a mouth that passes between the chamber and the external environment, in various aspects. The housing may be adapted for coupling to a steam source to allow steam to pass from the steam source into the chamber. The mouth of the chamber may be applied about a region so that steam may flow from the chamber through the mouth to contact the region.

The associated methods, in various aspects, may include the steps of biasing generally a mouth of a housing generally upon a surface of the region and introducing steam from a steam source into a chamber of the housing, and passing the steam from the chamber through the mouth onto the region. In various aspects, the steam may have sufficient temperature to exterminate insect pests that may be present about the region. The steam may have sufficient temperature to at least partially disinfect the region, in various aspects.

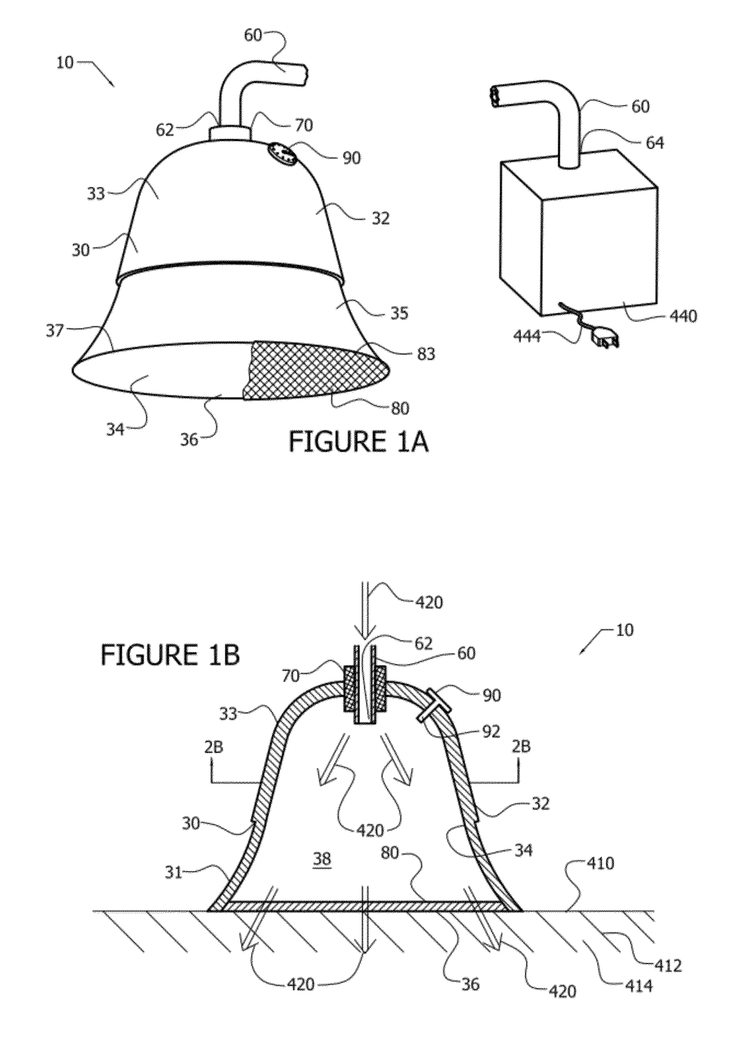

FIG. 1A illustrates by perspective view an exemplary extermination apparatus 10 for extermination of insect pests. As illustrated in FIG. 1, extermination apparatus 10 includes housing 30 defining exterior housing surface 32 and interior housing surface 34. As illustrated, interior housing surface 34 defines housing chamber 38 (see FIG. 1B). Housing 30 forms a mouth 36 that opens forth between chamber 38 and the exterior environment. Coupling 70 may be disposed about housing 30 and steam line 60 may be connected to coupling 70. As illustrated, steam line end 64 of steam line 60 is connected to steam supply 440 and steam line end 62 of steam line 60 is connected to coupling 70. Steam line end 62 may be slideably received within coupling 70 and may be frictionally secured within coupling 70, steam line end 62 may be secured to coupling 70 using various locking mechanisms, or steam line end 62 ma be secured to coupling 70 in various other ways or combinations of ways, in various implementations. The steam line end 62 may be removably secured to coupling 70 in some implementations, and steam line end 62 may be permanently secured to coupling 70 in other implementations. For example, in some implementation, the coupling 70 steam line end 62 may be formed in a generally unitary manner. The coupling 70 may be omitted in some implementations so that the steam line end 62 is generally received either permanently or removably by housing 30.

Steam line 60 may convey steam 420 (see FIG. 1B) from steam supply 440 into the chamber 38 of housing 30 through coupling 70. Steam supply 440 may be, for example, the ROBBY PRO 4L from T.P.A Impex S.p.a. Piazzetta Albere, 3/4 36060 Romano d'Ezzelino (VI), Italy or other suitable source of steam. The steam supply 440 may be generally portable in various implementations. The steam supply 440 produces steam by boiling of water in a reservoir therein, in various implementations. The water may be generally distilled or otherwise processed such that the water contains minimal dissolved or colloidal material in order to minimize deposition within the extermination apparatus or on the region to be treated. The steam supply 440 may be connectable to a source of electrical power such as mains electric by power cord 444 with the electric power used to produce the steam, in various implementations.

Temperature gage 90 is disposed about housing 30 to measure the temperature within chamber 38 of housing 30 to allow a user to monitor the temperature of the steam 420 therein. For example, temperature gage 90 may utilize a bimetallic strip or other suitable means for measuring the temperature within chamber 38.

As illustrated in FIG. 1A, extermination apparatus 10 includes bonnet 80 that covers mouth 36 of housing 30. The bonnet 80 may be composed of various fabrics, cloths, and other such woven or otherwise permeable materials through which steam 420 may pass (see FIG. 1B). Thus, steam 420 may pass from the chamber 38 through the mouth 36 including bonnet 80 to the external environment. The material that composes bonnet 80 may have various textures, roughnesses, fineness of weave and may be otherwise adapted in various ways depending upon the particular manner that extermination apparatus 10 is to be utilized. In various implementations, the material from which the bonnet 80 is formed may include cotton, wool, various synthetics such as nylon and rayon, or microfiber. As illustrated, bonnet 80 is secured about lip 37 of housing 30 by bonnet band 83 that elastically engages lip 37. The bonnet 80 may be removed to allow the bonnet 80 to be washed or replaced in this illustrated implementation.

In other implementations, for example as illustrated in FIG. 6, the bonnet 580 of extermination apparatus 500 may be composed of metal, plastic, or other generally non-permeable material. A plurality of holes 582 disposed therethrough to allow steam 420 to pass from the chamber, such as chamber 38, through the bonnet 580. In some implementation, the bonnet 80 may be generally compliant while, in other implementations, the bonnet 80 may be formed of a stiffer or generally more non-compliant material. In still other implementations, the bonnet 80 may be omitted so that steam 420 passes directly through mouth 36 of chamber 38 into the material being treated.

The housing may be formed generally of various metals such as stainless steel or aluminum, various plastics, combinations thereof or other materials and combinations of materials capable of withstanding the temperature of the steam 420. In the implementations illustrated in FIG. 1A, the housing 30 includes housing portion 35 formed of aluminum and housing portion 33 formed of hard plastic. The plastic housing portion 33 may insulate the housing 30 to prevent dissipation of heat from the chamber 38 and may provide a cooler surface by which a user may manipulate the housing 30. The aluminum housing portion 35 may be easily formable and lightweight and may have other advantages. Coupling 70, steam line 60 may be formed of various plastics, metals, combinations thereof, and other suitable material, as would be readily recognized by those of ordinary skill in the art upon review of the present disclosure.

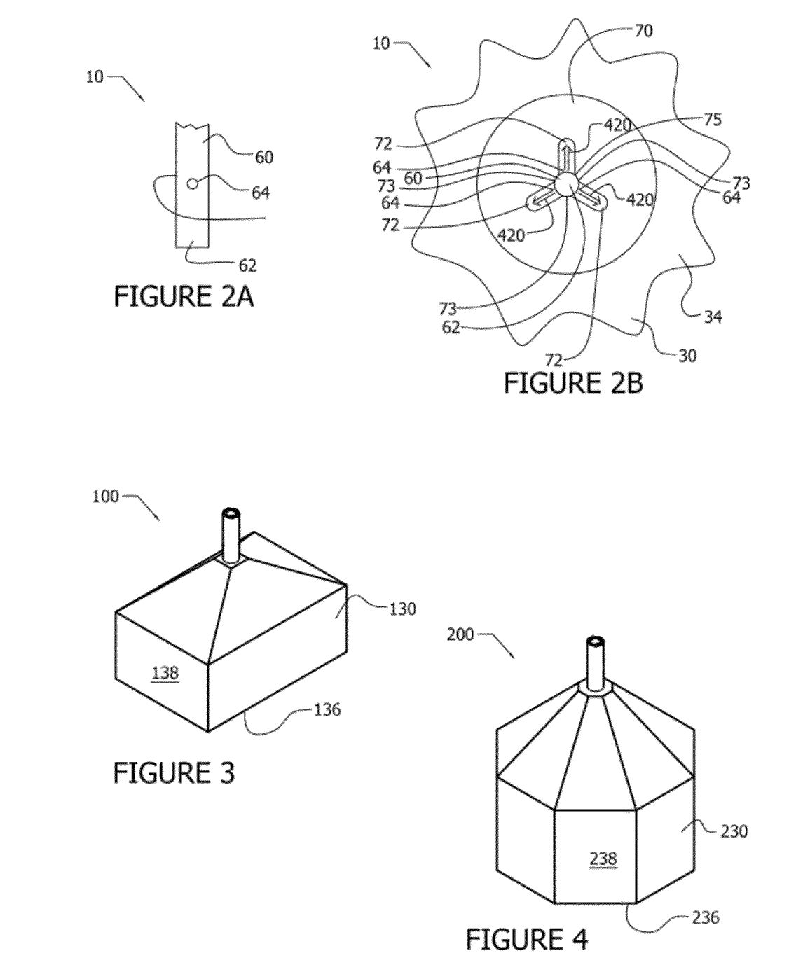

FIG. 1B further illustrates extermination apparatus 10. As illustrated in FIG. 1B, steam tube 60 is received within coupling 70. Steam 420 passes through steam line 60, and the steam 420 is introduced into chamber 38 through ports 64 (see FIGS. 2A & 2B) disposed about steam line end 62 of steam line 60. The steam 420 may turbulently mix within chamber 38 and the steam 420 may pass forth with a generally even distribution through mouth 36 of housing 30. Bonnet 80, which covers mouth 36 in this implementation, may enhance the generally even distribution of the steam 420 as the steam is distributed forth from mouth 36 through bonnet 80. In other implementations in which the bonnet 80 is omitted, the steam is distributed forth from mouth 36 to the external environment including region 412.

As illustrated in FIG. 1B, housing 30 is generally placed about surface 410 of region 412 in order to exterminate insect pests that may be present within region 412. Region 412 may be, for example, a portion of carpeting, a portion of a seat, a portion of the fabric covering of a sofa, bedding, wall covering, drape, curtain, and so forth. As illustrated, the steam 420 passes through the surface 410 of region 412 into the inner portions 414 of region 412 to exterminate insect pests that may lie therein. For example, if region 412 is a portion of a carpet, the steam 420 passes into the carpet to generally contact the pile and the backing so as to exterminate any insect pests located within the pile, the backing, or thereabouts.

As illustrated in FIG. 1B, probe portion 92 of temperature gage 90 extends into chamber 38 to allow the temperature gage 90 to measure the temperature of the steam 420 within chamber 38. The user may thus determine that the steam 420 within chamber 38 has a temperature sufficient to exterminate the insect pests and determine that the steam 420 within chamber 38 is not so hot as to damage the region 412 being treated. It has been found, for example, that a temperature of 71° C. (160° F.) will exterminate bedbugs in various applications. In various implementations, the steam may have a temperature within a range of from about 71° C. (160° F.) to about 93° C. (200° F.).

FIGS. 2A and 2B illustrate portions of extermination apparatus 10 including steam line end 62 of steam line 60 and steam line end 62 of steam line end 60 received in coupling 70. As illustrated in FIG. 2A, ports 64 are disposed about steam line end 62 of steam line 60. As illustrated in FIG. 2B, steam line end 62 of steam line 60 is received slideably within sleeve 75 of coupling 70. Steam line end 62 of steam line 60 may be oriented within sleeve 75, as illustrated, such that ports 62 align with slots 72 of coupling 70 so that steam 420 may flow through ports 62 into slots 72. The slots 72 may distribute the steam 420 into chamber 38 of housing 30. The steam line end 62 may be oriented in sleeve 75 such that sleeve portions 73 cover all or portions of ports 62 which may reduce the flow of steam 420 through ports 62 into the chamber 38 or may change the distribution of the steam from steam line 60 into chamber 38. In the implementation illustrated in FIG. 2A and FIG. 2B, the coupling 70 is generally at the apex of chamber 38. Three ports 64 are disposed about seam line end 62 of steam line 60. Other implementations may use various numbers of ports 64, for example, two ports 64 or four ports 64. In other implementations, ports, such as ports 64, may be located at other than the apex of chamber 38. Ports, such as ports 64, for the inlet of steam into chamber 38 may be distributed about chamber 38 in various ways, not just at the apex. In implementations having coupling 70, the coupling may be located generally about the apex of chamber 38, as illustrated, or may be located in other position(s) about chamber 38. A plurality of couplings, such as coupling 70, or a plurality of steam lines such as steam line 60 may be provided in various implementations. Housing 30 may include a plurality of chambers 38 in some implementations.

FIG. 3 illustrates another exemplary extermination apparatus 100 for extermination of insect pests. In the implementation illustrated in FIG. 3, extermination apparatus 100 includes housing 130 that defines chamber 138 with mouth 136. In the illustrative implementation of FIG. 3, the chamber 138 and mouth 136 have a generally rectangular shape. This may, for example, facilitate use of the extermination apparatus 100 in corners and other such rectangularly constrained regions.

FIG. 4 illustrates yet another exemplary extermination apparatus 200 for extermination of insect pests. In the implementation illustrated in FIG. 4, extermination apparatus 200 includes housing 230 that defines chamber 238 with mouth 236. In the illustrative implementation of FIG. 4, the chamber 238 and mouth 236 have a generally polygonal shape. The extermination apparatus for extermination of insect pests may be configured in other geometries and shapes suitable for various purposes in various implementations.

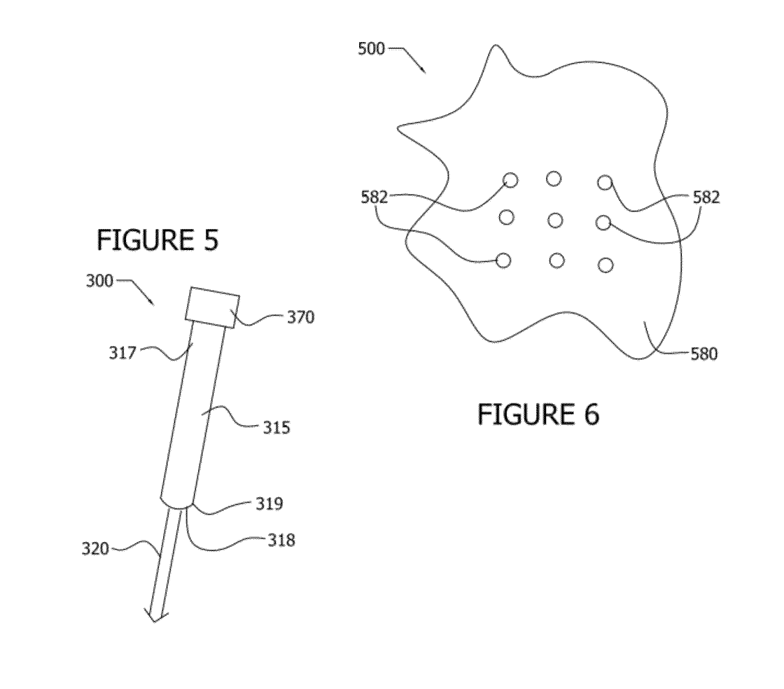

FIG. 5 illustrates extermination apparatus 300 for extermination of insect pests. Extermination apparatus 300 consists of tube 315 having coupling 370 at tube end 317 and defining tube opening 318 at tube end 319. Coupling 370 may be configured to receive a steam line end such as steam line end 62 of steam line 60 to convey steam 320 into tube 315 from a steam supply such as steam supply 440. Steam 320 may exit tube 315 though tube opening 318, as illustrated, and the steam 320 may be directed toward a region to be treated by pointing the tube opening 318 of tube 315 toward the area to be treated. This may be useful, for example, in treating various mechanisms such as the internal mechanisms of chairs, attachment points such as the attachment points of movie theater chairs to the floor, and in the treatment of locations within vehicles and other difficult to access locations as the steam 320 may be directed thereupon. Various nozzles and other features may be included about tube opening 318 to train the steam 320 as the steam 320 exits tube opening 318 in various implementations.

FIG. 6 illustrates a portion of a bonnet 580 of extermination apparatus 500 for extermination of insect pests. In this implementation, bonnet 580 may be composed of metal, plastic, or suchlike generally impermeable material or materials. Holes 582 are disposed about bonnet 580 to allow steam, such as steam 420, to pass therethrough. The holes 580 may be arranged in various regular or irregular patters in various implementations.

In operation, an extermination apparatus for extermination of insect pests, such as extermination apparatus 10, 100, 200, 500, may be positioned such that the mouth, such as mouth 36, 136, 236, of chamber, such as chamber 38, 138, 238, is generally oriented toward the region to be treated, for example region 412. Steam, such as steam 320, 420, may be supplied into the chamber. The steam may then exit the mouth of the chamber with a generally even distribution and may be dispersed over the portion of the region to be treated generally proximate the mouth of the chamber to exterminate insect pests within the region. A bonnet such as bonnet 80, 580 may be disposed over the mouth to aid in the dispersal of the steam in various implementations. The dispersion of steam over the region to be treated may be generally even in various implementations. In various implementations, the mouth may be sized or shaped to treat the particular region. For example, an extermination apparatus having a rectangular shaped mouth may be used to treat regions in corners. In various implementations, the steam temperature may be controlled such that the steam temperature is sufficient to kill the insect pests without damaging the material of the region to be treated.

In various implementation, an extermination apparatus such as extermination apparatus 300 may be used to direct steam into crevasses, onto mechanisms, and so forth. In various implementations, a vacuum cleaner may be used following use of the extermination apparatus to remove the remains of insect pests by vacuuming up these remains. In various implementations, the moisture deposited by the steam onto the region being treated is allowed to air dry.

In various implementations, the extermination apparatus, such as extermination apparatus 10, 100, 200, 500, may be used for cleaning of hard surfaces i.e., floors, countertops, walls etc., and a cotton or microfiber bonnet may be attached to the extermination apparatus when the extermination apparatus is so employed. The bonnet may be included or omitted from the extermination apparatus depending upon the nature of the region to which the steam is to be applied. For example, the bonnet may be included in the extermination apparatus such that the bonnet covers the mouth, when the extermination apparatus is used to apply steam to hard surfaces, and the bonnet may be omitted when the extermination apparatus is used to apply steam to carpet, bedding, drapes, and other cloth or suchlike regions.

In various implementations, the extermination apparatus, such as extermination apparatus 10, 100, 200, 500, may be used for disinfection, and the extermination apparatus may disinfect by virtue of the heat of the steam. In various implementations, the extermination apparatus, such as extermination apparatus 10, 100, 200, 500, may reduce the odor of tobacco smoke or other smoke odors. The steam may act to reduce these odors. In various implementations, speed of use of the extermination apparatus may be a factor in the design and footprint size of the extermination apparatus, such as extermination apparatus 10, 100, 200, 500. The extermination apparatus, such as extermination apparatus 10, 100, 200, 500, in various implementations, delivers controlled and captured steam temperatures to the desired location while preventing the escape of steam vapors. The steam passes through the mouth and into the region being treated. In some implementations, the temperature of the steam may be adjustable. In some implementations, the quality of the steam may be adjustable. In some implementations, the housing may be secured to a handle and the handle may be, for example, a pole or other elongated member to allow the user to use the extermination apparatus on a ceiling, high wall, or otherwise facilitate use of the extermination apparatus.

In various aspects, the extermination apparatus may be substantially quiet so that insect pests are not alerted to the presence of the extermination apparatus, and thus do not hide or escape or flee from the extermination apparatus. The noise of vapor steam spewing from a common vapor steam attachment may be eliminated with the vapor steam contained solely in the dome providing a form of a “sneak attack” to insect pests.

### EXPERIMENTAL RESULTS

Some experimental results were derived by Dr. Stephen A. Kells, Associate Professor, Dept. of Entomology, University of Minnesota, St. Paul, Minn. These experimental results are reported as follows.

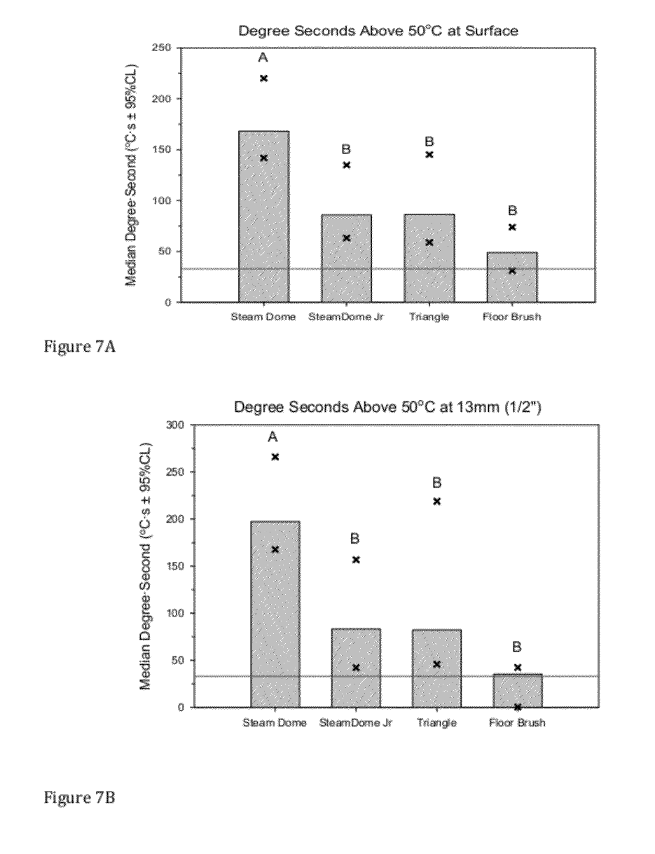

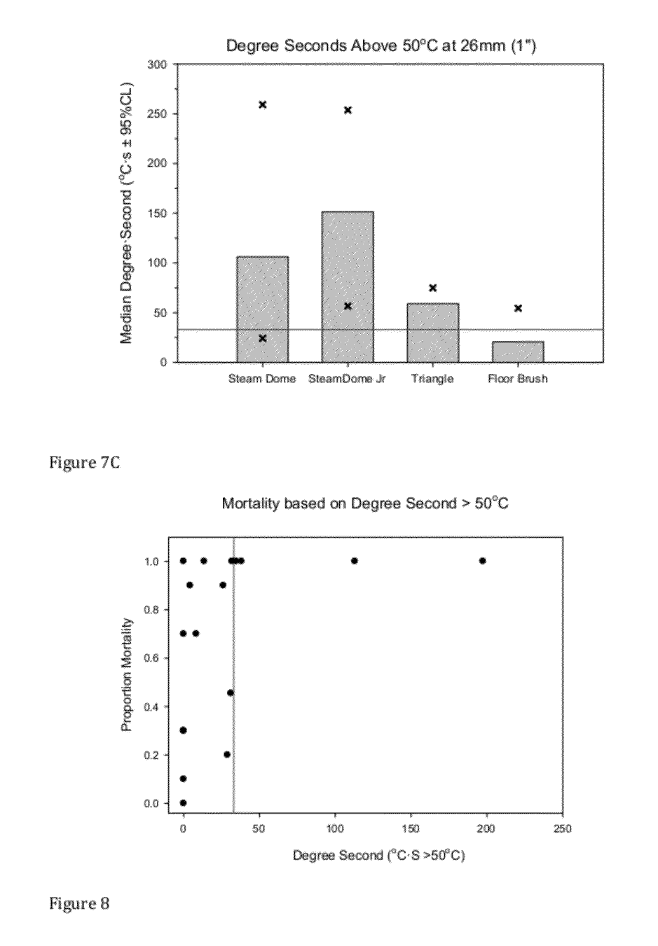

Two versions of the extermination apparatus, version 1 and version 2, generally configured as extermination apparatus 10 in FIGS. 1A, 1B, 2A, and 2B were tested. Version 1 of extermination apparatus 10 is referred to as the Steamdome in the experimental results presented in FIGS. 7A, 7B, and 7C. The diameter of mouth 36 of version 1 is approximately 8 ½ inches (21.6 cm), and the length between mouth 36 and coupling 70 (i.e. the apex of chamber 38) is roughly 5 inches (12.7 cm).

Version 2 of extermination apparatus 10 is referred to as the Steamdome Jr. in the experimental results presented in FIGS. 7A, 7B, and 7C. The diameter of mouth 36 in version 2 is approximately 5 ½ inches (14.0 cm), and the length between mouth 36 and coupling 70 (i.e. the apex of chamber 38) is roughly 4 ½ inches (11.4 cm).

Version 1 and version 2 of extermination apparatus 10 were tested on layers of polyester batting covered with a cotton sheet. Thermocouples were placed at different depths of the polyester to record temperature increases. Two types of trials were run, including steam penetration and mortality of adult bed bugs.

Regarding penetration of the steam into fabric, version 1 and version 2 of extermination apparatus 10 were compared against the standard triangular steam head and the floorbrush. The normal protocol is to pass the steam nozzle over the fabric with just enough pressure so the nozzle is just touching the fabric. The surface temperature is taken with non▭contact thermometer, just after the nozzle passes over an area. Nozzle speed was adjusted such that the surface temperature was between about 71° C. and about 82° C. (160° F. and 180° F.). To assess the heat delivery, the amount of degrees at each second that the temperatures were above 50° C. (or 122° F.) was used. This is termed Degree-Seconds herein. The Degree-Seconds were analyzed at each depth in the fabric. Each nozzle was run 5 times and the surface temperatures acted as a co▭variable in the analysis.

Under the same conditions, version 1 (Steamdome) outperformed the triangle and floor brushes (FIGS. 7A, 7B, & 7C). It delivered more Degree-Seconds than the other two brushes. It also penetrated the fabric better than the other two brushes. FIG. 7A illustrates the surface temperature, just under the cotton sheet; FIG. 7B illustrates penetration to 12 inch; and FIG. 7C illustrates penetration to 1 inch. Version 2 (Steamdome Jr.) was equivalent to the two brushes. It appears that the penetration was deeper to 1 inch into the fabric with the versions 1 and 2 of the extermination apparatus 10. The horizontal line in FIGS. 7A, 7B, and 7C is a mortality line that relates to bed bug mortality.

Bed bugs were placed in three places on the polyester batting, just under the top sheet. Along with the insects, a thermocouple was placed to measure temperature increase. When the run was set, a steam nozzle was passed over the fabric in a manner as previously described. For this work, the triangular brush was selected so the results would be comparable to previous work that was completed. It is the measurement of mortality versus Degree-Seconds that is important.

Below 33° Degree-Seconds (>50° C.) mortality of bed bugs was variable; proportional mortality was between 0 (no mortality) and 1 (complete mortality). The points above 33° Degree-Seconds resulted in complete mortality. This estimate, which is referred to as the mortality line, was placed on the graphs (FIGS. 7A, 7B, and 7C) as a reference point for where complete mortality is likely to occur. Version 1 of extermination apparatus 10 provided greater heat, well above this mortality estimate, while version 2 of extermination apparatus 10 was comparable to the traditional brushes.

FIGS. 7A, 7B, and 7C illustrate heat characteristics in Degree-Seconds above 50° C. (or 122° F.) from different steam nozzles. The letters (A and B) indicate significant differences in the temperature-time measurement among the nozzles. The mortality line indicates an approximate estimate of the minimum Degree-Seconds above 50° C. to cause complete mortality. The three graphs show temperature differences at the surface, ½″, and 1″ into the polyester batting, respectively.

FIG. 8 illustrates the mortality of bed bugs when exposed to different Degree-Seconds above 50° C. The line indicates an approximate estimate of the minimum Degree-Seconds above 50° C. to cause complete mortality; all points greater than 33° Degree-Seconds result in a proportional mortality of 1.

The foregoing discussion along with the Figures discloses and describes various exemplary implementations. These implementations are not meant to limit the scope of coverage, but, instead, to assist in understanding the context of the language used in this specification and in the claims. Accordingly, variations of the apparatus and methods that differ from these exemplary implementations may be encompassed by the appended claims. Upon study of this disclosure and the exemplary implementations herein, one of ordinary skill in the art may readily recognize that various changes, modifications and variations can be made thereto without departing from the spirit and scope of the inventions as defined in the following claims.

What is claimed is:

1. An extermination apparatus for extermination of insect pests, comprising:
a housing that defines a chamber within, the chamber having a mouth that may be interposed over a surface to be treated, the housing configured to admit steam from a steam supply into the chamber;
a bonnet disposed removably disposed over the mouth of the chamber, the bonnet permeable to steam to allow the steam to flow from the chamber through the mouth and through the bonnet disposed over the mouth.

2. The apparatus, as in claim 1, wherein the apparatus is adapted to deliver heat with degree-seconds above about 50° C. at a specified depth within a material to cause complete mortality of adult bed bugs at the specified depth.

3. The apparatus, as in claim 2, wherein the apparatus delivers heat with degree-seconds above about 50° C. of at least approximately 33° Degree-Seconds.

4. The apparatus, as in claim 3, wherein the specified depth is about 1 inch (2.54 cm).

5. The apparatus, as in claim 1, wherein the steam admitted into the chamber has a temperature generally within a range of from about 160° F. to about 200° F.

6. A method of extermination of bed bugs, comprising the steps of:
introducing steam into a chamber having a mouth with a steam permeable bonnet disposed over the mouth, the mouth interposed over a surface of a material;
delivering heat with degree-seconds above about 50° C. sufficient to cause complete mortality of adult bed bugs at a specified depth within the material.

7. The method, as in claim 6, wherein the step of delivering heat with degree-seconds above about 50° C. sufficient to cause complete mortality of adult bed bugs at a specified depth within the material delivers heat with degree-seconds above about 50° C. of at least approximately 33° Degree-Seconds.

8. The method, as in claim 6, wherein the specified depth is about 1 inch (2.54 cm).

9. The method, as in claim 6, wherein the steam introduced into the chamber has a temperature generally within a range of from about 160° F. to about 200° F.
